(19) United States
(12) Patent Application Publication
(10) Pub. No.: US 2022/0193641 A1
(43) Pub. Date: Jun. 23, 2022

(54) PREPARATION OF THREE-DIMENSIONAL MAGNETIC GAMMA MANGANESE DIOXIDE/ZINC IRON OXIDE NANOHYBRID ON GRAPHENE, AND USE THEREOF AS CATALYST FOR DECOMPOSING HARMFUL ORGANIC WASTE

(71) Applicant: RESEARCH COOPERATION FOUNDATION OF YEUNGNAM UNIVERSITY, Gyeongsan-si, Gyeongsangbuk-do (KR)

(72) Inventors: Jae-Jin SHIM, Daegu (KR); Amr Hussein Mady HUSSEIN, Gyeongsan-si, Gyeongsangbuk-do (KR)

(73) Assignee: RESEARCH COOPERATION FOUNDATION OF YEUNGNAM UNIVERSITY, Gyeongsan-si, Gyeongsangbuk-do (KR)

(21) Appl. No.: 17/606,090

(22) PCT Filed: Sep. 20, 2019
(86) PCT No.: PCT/KR2019/012200

§ 371 Date: Oct. 25, 2021

(30) Foreign Application Priority Data
Apr. 30, 2019 (KR) 10-2019-0050900

(51) Int. Cl. B01J 23/745; B01J 21/10; B01J 21/18; B01J 35/10; B01J 35/00; B01J 37/08

(52) U.S. Cl. CPC B01J 23/745; B01J 21/10; B01J 21/18; B01J 35/1019; B82Y 30/00; B01J 35/1061; B01J 35/0013; B01J 37/08; B01J 35/1023

(57) ABSTRACT

A nanohybrid includes: reduced graphene oxide (rGO); zinc ferrite (ZnFe₂O₄) nanoparticles dispersed in the rGO; and manganese dioxide (MnO₂) nanoflakes three-dimensionally attached on the rGO. The nanohybrid reduces recombination of graphene through the synergistic effects of MnO₂ nanoflakes, ZnFe₂O₄ nanoparticles, and graphene, and increases the surface area of the catalyst, thus being capable of exhibiting higher catalytic activity than the conventional δ-MnO₂@ZnFe₂O₄, γ-MnO₂@rGO, and ZnFe₂O₄@rGO composites in the decomposition of harmful organic waste.

### TECHNICAL FIELD

The present invention relates to preparation of a three-dimensional magnetic gamma manganese dioxide/zinc iron oxide nanohybrid on graphene and its use as a catalyst for decomposing harmful organic waste. More specifically, the present invention relates to preparation of a nanohybrid (MnO₂@ZnFe₂O₄/rGO) by attaching manganese dioxide (MnO₂) nanoflakes on reduced graphene oxide (rGO) in which zinc ferrite (ZnFe₂O₄) nanoparticles are dispersed and its use as a catalyst for decomposing harmful organic waste.

### BACKGROUND ART

Wastewater effluents from many industrial processes contain highly toxic refractory compounds, such as phenolic compounds, which can have detrimental effects on the environment and public health. Previous research has been carried out to degrade these pollutants by applying advanced oxidation processes (AOPs) characterized by highly efficient mineralization and non-selectivity. Among the various AOPs, Fenton and Fenton-like reactions are well-known and efficient reactions to degrade organic contaminants due to generation hydroxyl radicals (HO*), which are oxidizing radicals. On the other hand, these processes have some limitations, such as obstacles in transportation and storage of H₂O₂, pH limitations (2 to 4), metal leaching, and sludge production, which reduce their applicability.

Manganese-based materials have been applied in many areas because of their superior chemical and physical properties, high abundance in soil, and low toxicity to the environment compared to cobalt. As catalysts, they are used widely in AOPs due to the unique redox loop of manganese (Mn²⁻/Mn⁴⁺), which gives higher potential activity through a single electron transfer. Nevertheless, there has been a limitation in that separation of the manganese-based materials from a reaction solution is difficult because of their tendency to form superfine particles.

Accordingly, recently, researches have focused on development of magnetically separable MnO₂-based catalysts. The magnetic MnO₂-based catalysts, however, have a problem in that the performance for application as a catalyst is not excellent, such as having very low surface areas resulting in a long time for complete degradation of harmful organic waste.

Therefore, there is a need to develop a manganese-based catalyst that has a high surface area leading to excellent degradation efficiency of harmful organic wastes and is magnetically separable, and a manufacturing method thereof.

### DISCLOSURE

### Technical Problem

An object of the present invention is to provide a 3D T-MnO₂@ZnFe₂O₄/rGO nanohybrid catalyst which has a high surface area and excellent waste decomposition efficiency and is magnetically separable.

Another object of the present invention is to provide a method for preparing the 3D T-MnO₂@ZnFe₂O₄/rGO nanohybrid catalyst.

### Technical Solution

In order to achieve the above objects, the present invention provides a 3D MnO₂@ZnFe₂O₄/rGO nanohybrid catalyst containing reduced graphene oxide (rGO); zinc ferrite (ZnFe₂O₄) nanoparticles dispersed in the rGO; and manganese dioxide (MnO₂) nanoflakes attached three-dimensionally on the rGO.

Further, the present invention provides a catalyst for decomposing harmful organic waste containing the 3D MnO₂@ZnFe₂O₄/rGO nanohybrid catalyst and peroxymonosulfate (PMS).

Furthermore, the present invention provides a 3D MnO₂@ZnFe₂O₄/rGO nanohybrid catalyst preparation method including dispersing zinc ferrite (ZnFe₂O₄) nanoparticles in a graphene oxide (GO) solution to prepare a ZnFe₂O₄/GO solution; adding a manganese precursor and an acid to the ZnFe₂O₄/GO solution to prepare a suspension; and performing heat treatment of the suspension to obtain a nanohybrid (MnO₂@ZnFe₂O₄/rGO) with manganese dioxide (MnO₂) nanoflakes attached three-dimensionally on reduced graphene oxide (rGO) in which zinc ferrite (ZnFe₂O₄) nanoparticles are dispersed.

### Advantageous Effects

The 3D γ-MnO₂@ZnFe₂O₄/rGO nanohybrid catalyst of the present invention reduces graphene aggregation through synergetic effects of MnO₂ nanoflakes, ZnFe₂O₄ nanoparticles, and graphene, and can exhibit high catalytic activity in degrading harmful organic waste due to increase of the surface area of the catalyst compared to the existing δ-MnO₂@ZnFe₂O₄, γ-MnO₂@rGO, and ZnFe₂O₄@rGO composites.

In addition, the 3D γ-MnO₂@ZnFe₂O₄/rGO nanohybrid catalyst of the present invention has excellent reusability owing to the easy separation by magnets.

### BRIEF DESCRIPTIONS OF DRAWINGS

FIG. 1 is a diagram showing a preparation process of a 3D γ-MnO₂@ZnFe₂O₄/rGO nanohybrid by a hydrothermal synthesis method.

FIG. 2 shows XRD patterns of ZnFe₂O₄, ZnFe₂O₄@rGO, γ-MnO₂@rGO, δ-MnO₂@ZnFe₂O₄, and γ-MnO₂@ZnFe₂O₄/rGO.

FIG. 3 shows SEM and TEM images of ZnFe₂O₄@rGO (a, b), γ-MnO₂@rGO (c, d), δ-MnO₂@ZnFe₂O₄ (e, f), and γ-MnO₂@ZnFe₂O₄/rGO (g, h).

FIG. 4 shows (a) a HRTEM image, (b) EDS spectrum, and (c) elemental mapping images of γ-MnO₂@ZnFe₂O₄/rGO.

FIG. 5 shows SEM images of γ-MnO₂@ZnFe₂O₄/rGO nanohybrids, which were synthesized using different amounts of KMnO₄ and HCl:(a) 0.15 g KMnO_{4+0.33} ml HCl, (b) 0.225 g KMnO_{4+0.5} ml HCl, (c) 0.45 g KMnO₄₊₁ ml HCl, and (d) 0.6 g KMnO_{4+1.33} ml HCl.

FIG. 6 shows TEM images of γ-MnO₂@ZnFe₂O₄/rGO nanohybrids, which were synthesized using different amounts of KMnO₄ and HCl:(a) 0.15 g KMnO_{4+0.33} ml HCl, (b) 0.225 g KMnO_{4+0.5} ml HCl, (c) 0.45 g KMnO₄₊₁ ml HCl, and (d) 0.6 g KMnO_{4+1.33} ml HCl.

FIG. 7 shows XPS spectra of a γ-MnO₂@ZnFe₂O₄/rGO nanohybrid:(a) survey scan, (b) Mn 2p, (c) Fe 2p, (e) C is, and (f) O is energy regions.

FIG. 8 shows (a) Raman spectra of GO and the γ-MnO₂@ZnFe₂O₄/rGO nanohybrid, (b) FT-IR spectra of GO and the γ-MnO₂@ZnFe₂O₄/rGO nanohybrid, and (c) N₂ adsorption-desorption isotherm of the γ-MnO₂@ZnFe₂O₄/rGO nanohybrid (the inset presents pore-size distribution (PSD)).

FIG. 9 shows (a) degradation of phenol (20 mg/L) using ZnFe₂O₄@rGO, γ-MnO₂@rGO, δ-MnO₂@ZnFe₂O₄, and γ-MnO₂@ZnFe₂O₄/rGO, (b) effects of catalyst loading in the presence of 20 ppm phenol and 2 g/L PMS, and (c) effects of PMS loading in the presence of 20 ppm phenol and 0.2 g L⁻¹ catalyst.

FIG. 10 shows (a) an M-H hysteresis loop for the γ-MnO₂@ZnFe₂O₄/rGO nanohybrid at 300 K, and (b) a reusability test of the γ-MnO₂@ZnFe₂O₄/rGO nanohybrid for degradation of 20 ppm phenol using 0.2 g L⁻¹ catalyst and 2 g L⁻¹ PMS for five successive cycles.

FIG. 11 is a diagram showing phenol degradation mechanism of the γ-MnO₂@ZnFe₂O₄/rGO nanohybrid.

### MODES FOR CARRYING OUT INVENTION

Hereinafter, the present invention will be described in detail.

The present inventors prepared a 3D γ-MnO₂@ZnFe₂O₄/rGO nanohybrid catalyst using a simple hydrothermal method and have completed the present invention by determining that it can exhibit high catalytic activity in degrading harmful wastewater compared to the existing δ-MnO₂@ZnFe₂O₄, γ-MnO₂@rGO, and ZnFe₂O₄@rGO composites by reducing aggregation of graphene through the synergetic effects of MnO₂ nanoflakes, ZnFe₂O₄ nanoparticles, and graphene, and increasing activity of a radical source by increasing the surface area of the catalyst.

The present invention provides a 3D MnO₂@ZnFe₂O₄/rGO nanohybrid catalyst containing reduced graphene oxide (rGO); zinc ferrite (ZnFe₂O₄) nanoparticles dispersed in the rGO; and manganese dioxide (MnO₂) nanoflakes attached three-dimensionally on the rGO.

Here, the manganese dioxide (MnO₂) may have the gamma (γ) form, and an average thickness of the prepared manganese dioxide (MnO₂) nanoflakes may be 2 to 5 nm.

In addition, the MnO₂@ZnFe₂O₄/rGO nanohybrid can increase the Brunauer-Emmett-Teller (BET) specific surface area to 200 to 500 m² g⁻¹ by including pores with an average diameter of 2 to 15 nm, thus increasing the catalytic activity for degrading harmful organic waste.

Further, the present invention provides a catalyst for decomposing harmful organic waste, containing the 3D MnO₂@ZnFe₂O₄/rGO nanohybrid catalyst and peroxymonosulfate (PMS).

Here, a high-efficiency catalytic effect can be exhibited through the high surface area of the 3D MnO₂@ZnFe₂O₄/rGO nanohybrid catalyst and sulfate radicals generated by activation of PMS by MnO₂ and ZnFe₂O₄. Particularly, in the case that 0.2 g L⁻¹ δ-MnO₂@ZnFe₂O₄/rGO nanohybrid and 2.0 g L⁻¹ PMS are added, harmful organic waste can be completely degraded within a short time.

Further, the present invention provides a 3D MnO₂@ZnFe₂O₄/rGO nanohybrid catalyst preparation method including dispersing zinc ferrite (ZnFe₂O₄) nanoparticles in a graphene oxide (GO) solution to prepare a ZnFe₂O₄/GO solution; adding a manganese precursor and an acid to the ZnFe₂O₄/GO solution to prepare a suspension; and performing heat treatment of the suspension to obtain a nanohybrid (MnO₂@ZnFe₂O₄/rGO) with manganese dioxide (MnO₂) nanoflakes attached three-dimensionally on reduced graphene oxide (rGO) in which zinc ferrite (ZnFe₂O₄) nanoparticles are dispersed.

Here, the manganese precursor may be any one selected from the group consisting of potassium permanganate (KMnO₄), manganese nitrate (Mn(NO₃)₂), manganese hydrochloride (MnCl₂), manganese sulfate (MnSO₄), and manganese acetate (Mn(CH₃COO)₂), but is not limited thereto.

In addition, the acid may be any one selected from the group consisting of hydrochloric acid (HCl), sulfuric acid (H₂SO₄), and nitric acid (HNO₃), but is not limited thereto.

In addition, 0.1 to 0.7 g of the manganese precursor may be included, and 0.3 to 2.0 mL of the acid may be included. Preferably, 0.45 g of the manganese precursor and 1 mL of the acid may be included.

In addition, the heat treatment of the suspension may be performed at 50 to 150° C. for 5 to 20 hours, and preferably, at 100° C. for 12 hours, but is not limited thereto.

Here, in the case of exceeding the conditions of the preparation method, the nanohybrid (MnO₂@ZnFe₂O₄/rGO) with manganese dioxide (MnO₂) nanoflakes attached three dimensionally on reduced graphene oxide (rGO) in which zinc ferrite (ZnFe₂O₄) nanoparticles are dispersed according to the present invention is not formed properly, so the catalytic activity is not excellent, which may cause a problem that it cannot be usefully used as a catalyst for decomposing harmful organic waste.

In addition, an average thickness of the prepared manganese dioxide (MnO₂) nanoflakes may be 2 to 5 nm, and the MnO₂@ZnFe₂O₄/rGO nanohybrid may include pores having an average diameter of 2 to 15 nm to increase the BET specific surface area to 200 to 500 m²/g, thereby increasing the catalytic activity for decomposing harmful organic waste.

According to the present invention, the nanohybrid (MnO₂@ZnFe₂O₄/rGO) with manganese dioxide (MnO₂) nanoflakes attached three-dimensionally on reduced graphene oxide (rGO) in which zinc ferrite (ZnFe₂O₄) nanoparticles are dispersed was prepared simply using the hydrothermal self-assembly synthesis method. This nanohybrid exhibited a high BET specific surface area which is an important property for excellent catalytic activity, through the synergistic effects of MnO₂, ZnFe₂O₄, and graphene. Further, it exhibited a high-efficiency catalytic effect through the sulfate radicals (SO₄*) generated by the activation of PMS by MnO₂ and ZnFe₂O₄, could be recovered easily using a magnet, and could be reused more than 5 times. Therefore, since the nanohybrid catalyst according to the present invention has excellent catalytic activity and reusability, it may be usefully applied to removal of hard-to-degrade waste materials.

Hereinafter, the present invention will be described in detail through examples. It would be clear to a person skilled in the art that these examples are merely for illustrating the present invention specifically and that the scope of the present invention is not limited by the examples.

### <Example 1>Preparation of 3D δ-MnO₂@ZnFe₂O₄/rGO Nanohybrid Catalyst

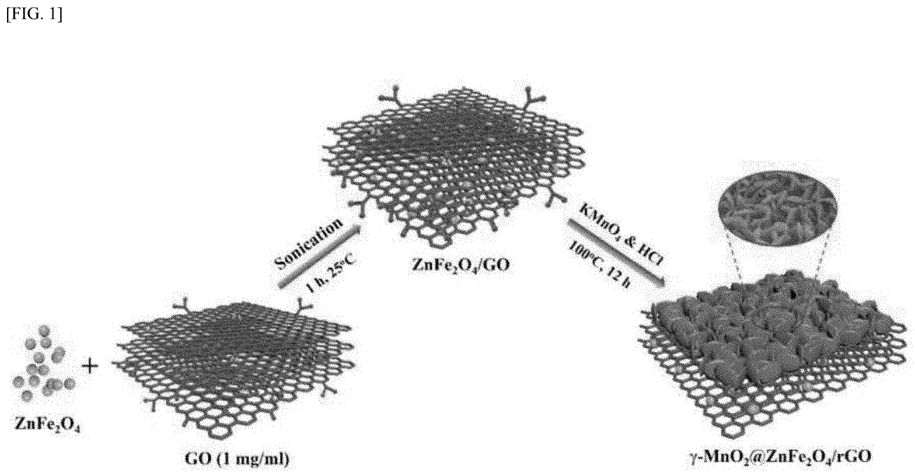

All materials used below were of high purity grade, purchased from Sigma-Aldrich, and used as received without further purification. Graphene oxide (GO) was generated using Tour's method (ACS Nano, 4 (2010) 4806-4814; 12 (2018) 2078). FIG. 1 describes synthesis of a 3D δ-MnO₂@ZnFe₂O₄/rGO nanohybrid including dispersion by sonication of 0.24 g of ZnFe₂O₄, which was synthesized previously via a hydrothermal method (Mater. Res. Bull. 45 (2010) 755-760), in an aqueous solution of 80 mL GO (1 mg ml⁻¹) for 1 hour. Subsequently, 0.45 g of KMnO₄ and 1 mL of HCl (37%) were added to the ZnFe₂O₄ dispersed GO aqueous solution with stirring for 30 minutes. After the above process, the resulting suspension was transferred to a 120 mL autoclave and heat-treated at 100° C. for 12 hours. After the reaction, the autoclave was cooled down naturally to room temperature. Then, samples were collected by centrifugation, washed with deionized water, and dried in a vacuum oven at room temperature for 30 minutes to prepare a nanohybrid catalyst (hereinafter, referred to as ‘3D δ-MnO₂@ZnFe₂O₄/rGO’).

### <Comparative Example 1>Preparation of δ-MnO₂@ZnFe₂O₄ Catalyst

A catalyst was prepared using the same process described above for Example 1 except that GO was not included (hereinafter, referred to as ‘δ-MnO₂@ZnFe₂O₄’).

### <Comparative Example 2>Preparation of γ-MnO₂@rGO Catalyst

A catalyst was prepared using the same process described above for Example 1 except that ZnFe₂O₄ was not included (hereinafter, referred to as ‘γ-MnO₂@rGO’).

### <Comparative Example 3>Preparation of ZnFe₂O₄@rGO Catalyst

A catalyst was prepared using the same process described above for Example 1 except that MnO₂ was not included (hereinafter, referred to as ‘ZnFe₂O₄@rGO’).

### <Example 2>Analysis

Powder X-ray diffraction (XRD; PANalytical, X′Pert-PRO MPD) was carried out using Cu Kα radiation. The structural information of the samples was analyzed using Fourier-transform infrared (FT-IR; Bio-Rad, Excalibur Series FTS 3000) spectroscopy and Raman spectroscopy (Horiba, XploRA plus). X-ray photoelectron spectroscopy (XPS; Kratos Analytical, AXIS Nova) was used to examine the surface components of the samples. The Brunauer-Emmett-Teller (BET) specific surface area (S_{BET}) and pore size distribution (PSD) of the samples were investigated using an N₂ adsorption-desorption apparatus (Micromeritics 3Flex Surface Characterization Analyzer). Field-emission scanning electron microscopy (FE-SEM; Hitachi, S-4800) and transmission electron microscopy (TEM; Philips, CM 200) were used to determine the morphology and structure of the samples. Magnetization measurements were carried out at room temperature using a vibrating sample magnetometer (VSM; Dexing, Model 250). The metal content of the composite was analyzed by inductively coupled plasma atomic emission spectroscopy (ICP-AES; PerkinElmer, Optima 8300).

### <Example 3>Catalytic Activity Measurement

In a catalytic activity measurement test, a 10 mg of catalyst was added to 50 mL of 20 ppm phenol solution, which was then stirred for 30 minutes to achieve adsorption-desorption equilibrium. Then, to start reaction tests, 0.3 mM peroxymonosulfate (PMS) was added to the reaction solution. After a certain period of time, 1.5 mL of the aqueous sample was withdrawn using a syringe and filtered into a vial. The concentration of phenol was analyzed by high-performance liquid chromatography (HPLC; Young Lin, Series YL9100) equipped with a YL9120 UV/Vis detector; the UV wavelength was adjusted to 275 nm. A C-18 column (Sun Fire) was used to separate the organic solution from a mobile solution at a flow rate of 1 mL min⁻¹. The eluent was prepared by mixing water, 1 vol. % acetic acid solution, and methanol in the ratio of 50:40:10. To examine catalytic stability and reusability, the nanohybrid was used 5 times. After each experiment, it was collected using a magnet, washed with deionized water, and dried in a vacuum oven at room temperature.

### <Experimental Example 1>Structural Analysis of 3D γ-MnO₂@ZnFe₂O₄/rGO Nanohybrid

1. XRD Analysis

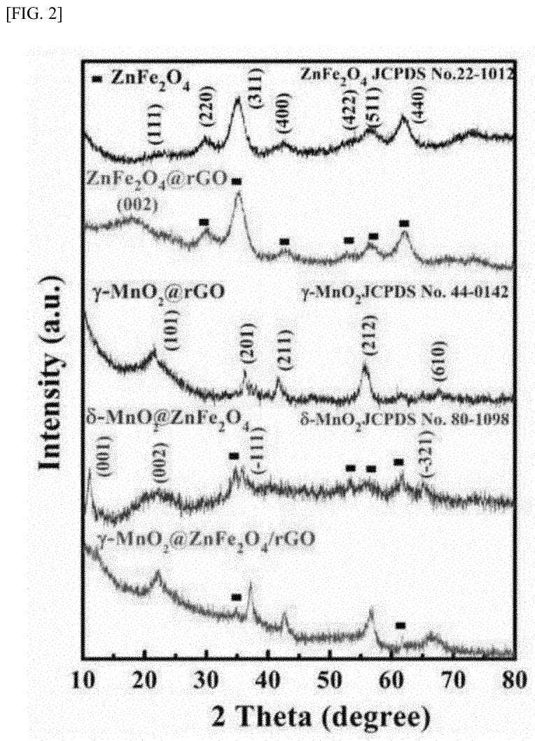

XRD analysis was performed on ZnFe₂O₄ and the composites of Example 1 and Comparative Examples 1 to 3 to determine the crystalline structure of the γ-MnO₂@ZnFe₂O₄/rGO nanohybrid (FIG. 2). As a result, for ZnFe₂O₄, the XRD peaks at 30.1, 35.26, 42.8, 53.2, 56.6, and 62.2° 2θ were indexed to the (220), (311), (400), (422), (511), and (440) crystal planes of spinel ZnFe₂O₄ (JCPDS 22-1012), respectively, which confirmed formation of a cubic structure. In addition, a weak broad peak was observed at 22° 2θ, which was indexed to the (002) plane of reduced graphene oxide in the ZnFe₂O₄@rGO nanocomposite. The characteristic XRD peaks of γ-MnO₂ were observed in both γ-MnO₂@rGO and the nanohybrid γ-MnO₂@ZnFe₂O₄/rGO, at 22.2, 36.1, 42.2, 55.6, and 67.9° 2θ, which were indexed to the (101), (201), (211), (212), and (610) planes, respectively, of Ramsdellite γ-MnO₂ (JCPDS 44-0142). Furthermore, no XRD peaks of S—MnO₂ were observed in the γ-MnO₂@ZnFe₂O₄/rGO nanohybrid, confirming that the MnO₂ is present only in the gamma (γ) form. The XRD peak of rGO was not detected in the γ-MnO₂@ZnFe₂O₄/rGO nanohybrid due to the anchoring of ZnFe₂O₄ nanoparticles (NPs) as spacers and 3D γ-MnO₂ nanoflakes on the rGO surface, which can minimize re-stacking of rGO sheets.

2. SEM, TEM Analysis

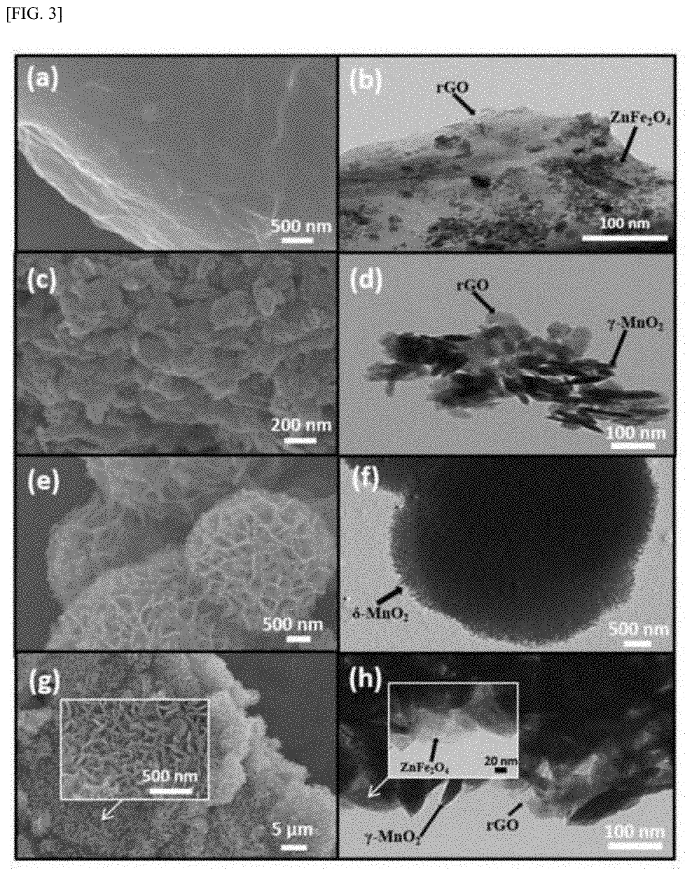

FIG. 3 shows SEM and TEM images of the samples. FIGS. 3a and 3b show SEM and TEM images of ZnFe₂O₄@rGO, respectively, which show that all ZnFe₂O₄ NPs were intercalated between the graphene nanosheets. Further, the SEM (FIG. 3c) and TEM (FIG. 3d) images of γ-MnO₂@rGO showed aggregated nanoflakes of γ-MnO₂ deposited on the rGO nanosheets. The SEM (FIG. 3e) and TEM (FIG. 3f) images of δ-MnO₂@ZnFe₂O₄ showed a microspherical structure with a uniform hydrangea-like structure with a diameter of 3-5 m. FIGS. 3g and 3h are SEM and TEM images of the γ-MnO₂@ZnFe₂O₄/rGO nanohybrid, which show an intimate combination of 3D γ-MnO₂ nanoflakes, 2-5 nm in thickness, anchored on the rGO nanosheets intercalated with ZnFe₂O₄. Such a combination showed high chemical performance due to rapid transportation of electrons between the γ-MnO₂ nanoflakes and the rGO nanosheets intercalated with ZnFe₂O₄ NPs.

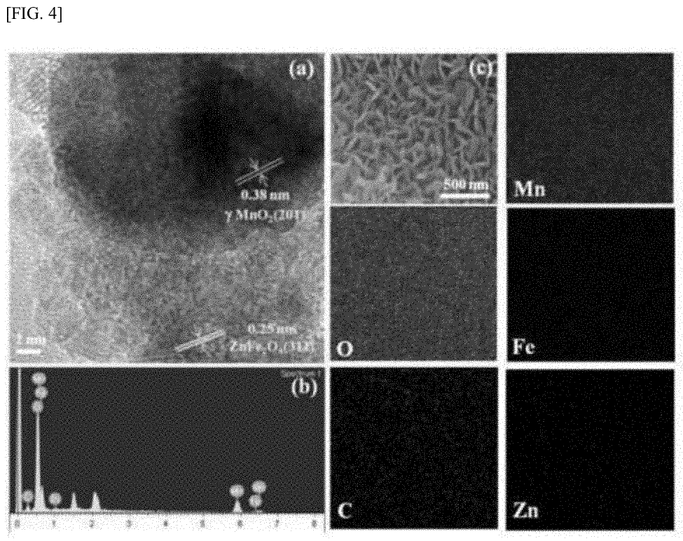

The HRTEM image in FIG. 4a shows well-resolved lattice fringes with typical d-spacings of 0.38 and 0.25 nm, which correspond to the (201) plane of MnO₂ and the (311) plane of ZnFe₂O₄, respectively. EDS of the γ-MnO₂@ZnFe₂O₄/rGO nanohybrid (FIG. 4b) indicated the presence of Mn, O, C, Fe, and trace amounts of Zn, which was due to partial leaching of Zn from zinc ferrite after the addition of HCl during the preparation process. The elemental mapping images (FIG. 4c) showed that Mn, Fe, and Zn were dispersed uniformly on the rGO nanosheets, which further confirmed the successful synthesis of the γ-MnO₂@ZnFe₂O₄/rGO nanohybrid.

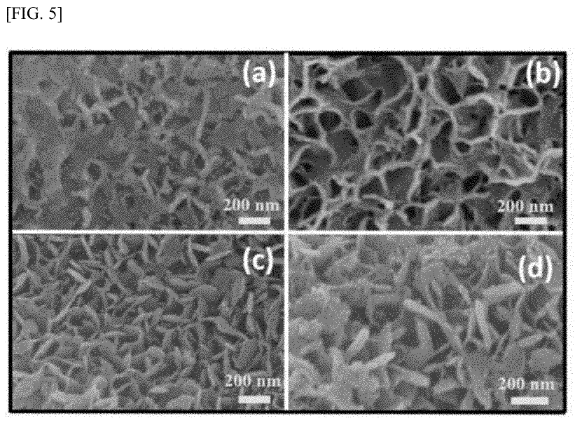

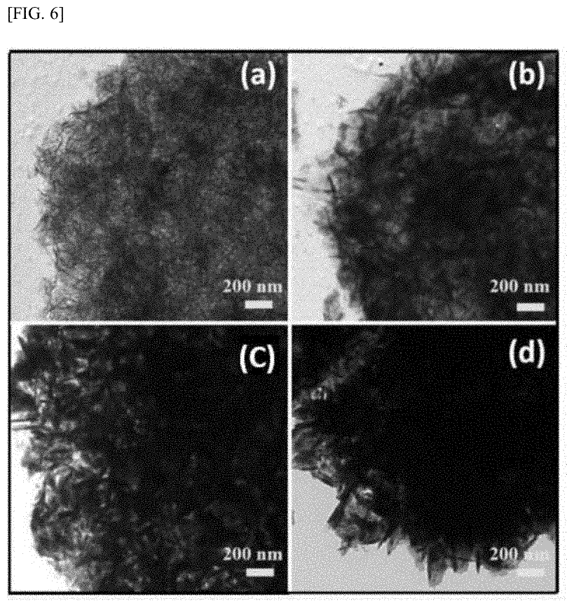

Based on the experimental results, a possible mechanism was proposed to understand growth mechanism of MnO₂ nanoflakes on rGO sheets (FIGS. 5 and 6). In the first step, ZnFe₂O₄ was dispersed in the graphene oxide solution by sonication for 1 hour to intercalate the ZnFe₂O₄ nanoparticles between GO sheets. Subsequently, different amounts of KMnO₄ and HCl were used to induce the growth of MnO₂ nanoflakes. As a result, using a small amount of KMnO₄ (0.15 g), the Mn²+ions in the solution bound with the negatively charged oxygen-containing functional groups of GO sheets via electrostatic force, the addition of 0.33 ml HCl to the solution of ZnFe₂O₄/GO and KMnO₄ resulted in oxidation of Mn²⁺ ions to MnO₂, and nucleated MnO₂ combined on the surface of the GO sheets and started growing into nanoflakes (FIGS. 5a and 6a). Then, increasing the amounts of KMnO₄ and HCl to 0.45 g and 1 ml, respectively, resulted in the formation of MnO₂ nanoflakes on the rGO sheets without aggregation (FIGS. 5c and 6c). However, increases in the amounts of KMnO₄ and HCl to 0.6 g and 1.33 ml, respectively, produced aggregated MnO₂ nanoflakes on the surface of rGO (FIGS. 5d and 6d), enabling preparation of the 3D γ-MnO₂@ZnFe₂O₄/rGO nanohybrid catalyst.

3. XPS Analysis

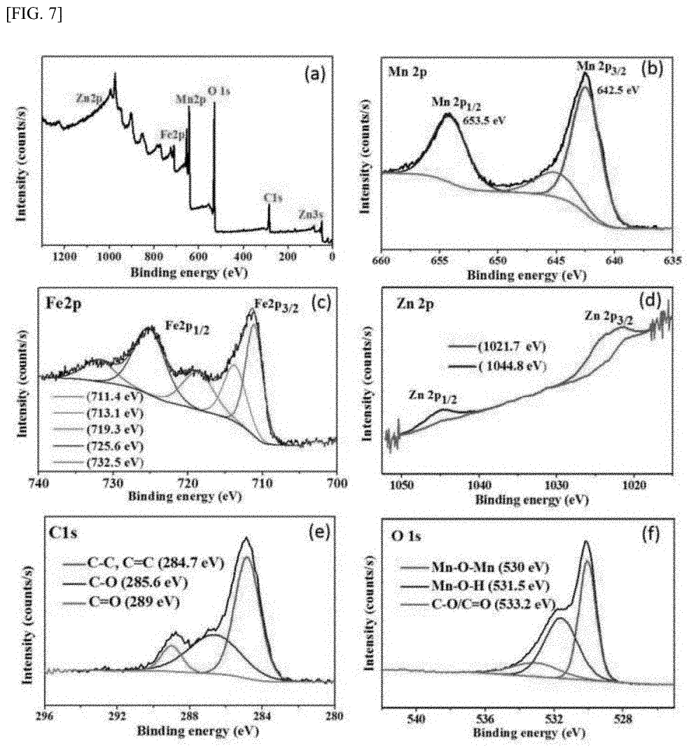

The chemical bonding state of the γ-MnO₂@ZnFe₂O₄/rGO nanohybrid was analyzed by XPS (FIG. 7). As shown in FIG. 7a, the survey spectrum revealed the existence of Mn2p, Fe 2p, Zn 2p, O 1 s, and C 1 s energy regions. The Mn 2p spectrum of FIG. 7b revealed two main peaks at approximately 642.5 and 654.2 eV, corresponding to the binding energies of Mn2p_{3/2} and Mn 2p_{1/2}, respectively. The spin energy separation between Mn2p_{3/2} and Mn 2p_{1/2} was 11.7 eV, showing good agreement with the known spectra of MnO₂ and also revealing the formation of MnO₂ on the rGO/ZnFe₂O₄ hybrid. The Fe 2p spectrum in FIG. 7c shows the binding energies of Fe 2p_{3/2} at 711.4 and 713.1 eV, which correspond to the octahedral and tetrahedral sites, respectively. The peak at 725.6 eV for Fe 2p_{1/2} and the two satellite peaks at 719.3 and 732.5 eV suggest that only Fe³⁺exists in the ZnFe₂O₄ particles in the nanohybrid. The Zn 2p spectrum in FIG. 7d shows two major peaks centered at 1044.8 and 1021.7 eV, which were assigned to Zn 2p_{1/2} and Zn 2p_{3/2}, respectively. The low intensity of these two Zn 2p peaks was attributed to the leaching of zinc from the zinc ferrite sample during preparation of the hybrid, which was also confirmed by the EDS analysis. The O is region in FIG. 7f showed three peaks centered at 530.0, 531.5, and 533.2 eV, which were assigned to Mn—O—Mn, Mn—O—H, and C—O/C═O bonds, respectively. For the C is spectrum in FIG. 7e, the main peak is located at 284.7 eV, which was attributed to C—C and C═C bonds, whereas the two weak peaks centered at 285.6 and 289.0 eV correspond to C—O and C═O bonds, respectively.

4. Raman Spectrum Analysis

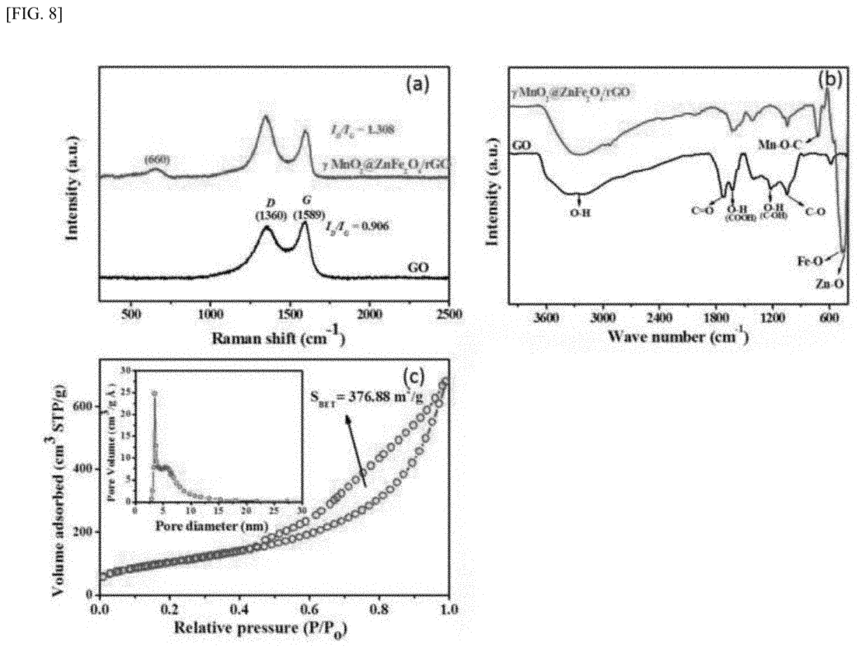

FIG. 8a shows the Raman spectra of both GO and γ-MnO₂@ZnFe₂O₄/rGO nanohybrid. As a result, two characteristic peaks corresponding to the D-band (1360 cm⁻¹), which originated from disorder and defects of carbon materials, and the G-band (1589 cm⁻¹), which was attributed to the vibration of sp²-hybridized carbon, were present in both samples. After the hydrothermal reduction treatment, the ID/IG intensity ratio for GO increased from 0.906 to 1.308 in the γ-MnO₂@ZnFe₂O₄/rGO nanohybrid due to an increase in the degree of defects and disorder and a decrease in the mean size of the sp² domains. The increase in the ID/IG ratio confirmed that GO had been deoxygenated and reduced to rGO. The peak at 646 cm⁻¹ corresponds to the A_{g} mode of MnO₂, which originates from the MnO₆ octahedral breathing vibrations. This shows that MnO₂ had been anchored successfully on the rGO sheets.

5. FT-IR Analysis

Evidence for the reduction of oxygen functional groups on the GO surface was obtained from the FT-IR spectra of GO and γ-MnO₂@ZnFe₂O₄/rGO nanohybrid, as shown in FIG. 8b. The characteristic peaks of GO can be observed at 1056.8 cm⁻¹ (stretching vibrations of epoxy groups, C—O), 1398.5 cm⁻¹ (O—H deformation vibrations of tertiary C—OH), 1625.3 cm⁻¹ (0—H deformation vibrations of COOH groups), and 1721.0 cm⁻¹ (C═O stretching vibrations of COOH groups). The broad absorption peak from 3100 to 3700 cm⁻¹ is assigned to the O—H stretching vibration. In contrast, after the hydrothermal reduction treatment, most of the oxygen-containing functional groups in the γ-MnO₂@ZnFe₂O₄/rGO nanohybrid had been minimized. The C═O band disappeared, and the band intensities of O—H and C—O decreased, indicating the partial reduction of GO. Finally, the two strong absorption peaks in the spectrum of γ-MnO₂@ZnFe₂O₄/rGO at wavelengths lower than 722.1 and 550 cm⁻¹ were assigned to the stretching vibrations of Mn—O—C and Fe—O bonds, respectively, and the weak absorption peak at 433.9 cm⁻¹ was attributed to the Zn—O bond due to the leaching of zinc, as mentioned above.

6. S_{BET}, PSD Analysis

As shown in FIG. 8c, S_{BET} and PSD of the γ-MnO₂@ZnFe₂O₄/rGO were analyzed. According to the IUPAC classification, the γ-MnO₂@ZnFe₂O₄/rGO nanohybrid showed a type IV isotherm with an H3 hysteresis loop, indicating its mesoporous nature. The S_{BET} of γ-MnO₂@ZnFe₂O₄/rGO was calculated to be 376.9 m² g⁻¹. The inset in FIG. 8c presents the PSD of γ-MnO₂@ZnFe₂O₄/rGO, showing a sharp maximum at approximately 3.5 nm and a broad peak at 5.5 nm with a resulting average pore diameter of 8.15 nm, which exhibited a superior S_{BET} value compared to the catalysts of Comparative Examples 1 to 3 as shown in Table 1 below. The high surface area allows for efficient transportation of pollutants to the active sites of the catalyst and provides more adsorption/reaction sites for peroxymonosulfate (PMS) activation during the catalytic reaction, which results in higher catalytic activity.

TABLE 1

| | | Pore | Average pore | First order | |
|---|---|---|---|---|---|
| | S_{BET} | Volume | diameter | rate constant | |
| Sample | (m² g⁻¹) | (cm³ g⁻¹) | (nm) | (min⁻¹) | R² |
| γ-MnO₂@ZnFe₂O₄/rGO | 376.9 | 1.055 | 8.15 | 0.094 | 0.9912 |
| δ-MnO₂@ZnFe₂O₄ | 223.0 | 0.942 | 16.66 | 0.033 | 0.972 |
| γ-MnO₂@rGO | 46.0 | 0.246 | 24.98 | 0.0235 | 0.988 |
| ZnFe₂O₄@rGO | 153.9 | 0.339 | 8.13 | 0.0114 | 0.983 |

### <Experimental Example 2>Catalytic Activity

1. Catalytic Activity of γ-MnO₂@ZnFe₂O₄/rGO Nanohybrid

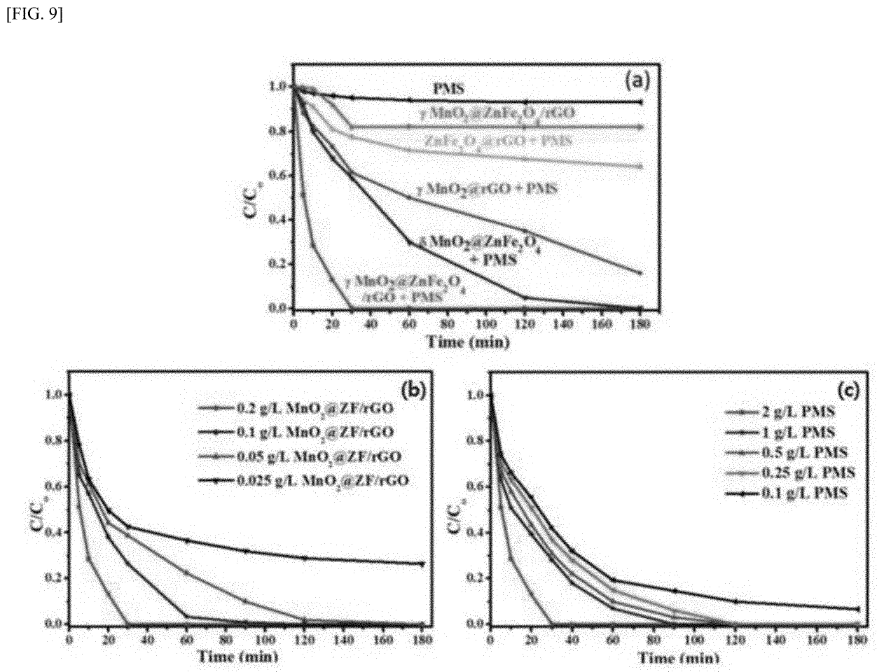

The catalytic performance of the γ-MnO₂@ZnFe₂O₄/rGO nanohybrid and the other composites for phenol degradation via peroxymonosulfate (PMS) activation was analyzed (FIG. 9a). Control experiments for catalytic activity using PMS only and γ-MnO₂@ZnFe₂O₄/rGO nanohybrid without PMS were conducted. As a result, the sample using the γ-MnO₂@ZnFe₂O₄/rGO nanohybrid and PMS showed the highest catalytic efficiency among all the samples tested. Further, in the absence of a catalyst, PMS could not be activated and the amount of sulfate radicals (SO₄′⁻) generated was insufficient to degrade the 20 ppm phenol solution. Furthermore, the use of the γ-MnO₂@ZnFe₂O₄/rGO nanohybrid without the addition of PMS resulted in the adsorption of approximately 20% of phenol after 3 hours. By combining PMS with the composites, PMS was activated on the active sites of the metal oxides, and the catalytic activity of the composites was observed in the following order: γ-MnO₂@ZnFe₂O₄/rGO >δ-MnO₂@ZnFe₂O₄ >γ-MnO₂@rGO >ZnFe₂O₄@rGO.

In particular, the γ-MnO₂@ZnFe₂O₄/rGO nanohybrid showed complete degradation of 20 mg L^{_}(20 ppm) phenol after 30 min in the presence of PMS. A comparison with the results of the other composites revealed 22, 39, and 41% phenol degradation on ZnFe₂O₄@rGO, γ-MnO₂@rGO, and δ-MnO₂@ZnFe₂O₄, respectively, indicating the synergetic effects on catalytic activity of combining MnO₂, ZnFe₂O₄, and rGO into a nanohybrid. This high-efficiency catalytic effect is attributed to the high surface area of the nanohybrid compared to the other composites (Table 1) and the ability of both MnO₂ and ZnFe₂O₄ to activate PMS through an electron transfer mechanism to produce sulfate radicals (Eqs. (1) to (4) below). As a result, the composites containing both MnO₂ and ZnFe₂O₄ showed high catalytic efficiency compared to other composites lacking one of them (FIG. 9a). In addition, the rGO sheets increased the adsorption property of the nanohybrids through 7L-7L stacking interactions between phenol and the aromatic region of the graphene sheets. Moreover, the uniform dispersion of MnO₂ nanoflakes over the rGO surface (FIG. 4c) can provide more active sites for phenol degradation. The high efficiency of the nanohybrid is also due to the strong bonding between MnO₂ and graphene (Mn—O—C), which was confirmed by the O is deconvolution of the XPS data (FIG. 7f).

Further analysis of the performance of the γ-MnO₂@ZnFe₂O₄/rGO nanohybrid under different reaction conditions was carried out and the effects of catalyst loading and PMS loading were analyzed (FIGS. 9b and 9c). The efficiency of phenol degradation increased with increasing amounts of nanohybrid and PMS due to increase in the number of active sites and active sulfate radicals SO₄′⁻, respectively. In particular, 0.2 g L⁻¹γ-MnO₂@ZnFe₂O₄/rGO nanohybrid loading and 2.0 g L⁻¹ PMS loading showed complete degradation of 20 mg L⁻¹ (20 ppm) phenol after 30 minutes.

2. Magnetism and Reusability of γ-MnO₂@ZnFe₂O₄/rGO Nanohybrid Catalyst

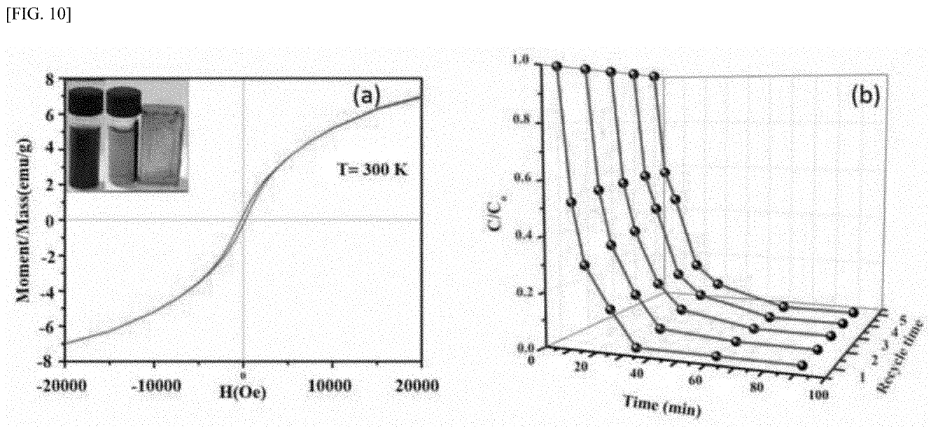

The catalyst magnetism and reusability of the γ-MnO₂@ZnFe₂O₄/rGO nanohybrid were evaluated from successive catalytic experiments by taking advantage of the magnetic property of the nanohybrid, which exhibited paramagnetic behavior and a slim hysteresis loop with a saturation magnetization value of approximately 7 emu g⁻¹ at 2 θ,000 Oe, magnetic coercivity (Hc) of 293.67 Oe, and remanence (M_{R}) of 0.266 emu g⁻¹ (FIG. 10a and inset). In addition, the γ-MnO₂@ZnFe₂O₄/rGO nanohybrid showed a similar rate of phenol degradation after 5 cycles as shown in FIG. 10b, indicating the potential reusability of the nanohybrid.

3. Catalytic Mechanism of γ-MnO₂@ZnFe₂O₄/rGO Nanohybrids

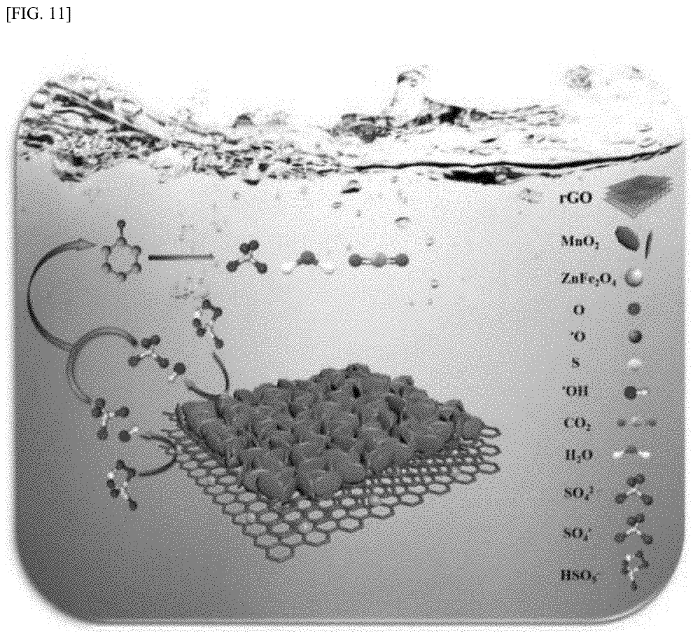

Based on the above results, an activation mechanism of peroxymonosulfate (PMS) on the active sites of the γ-MnO₂@ZnFe₂O₄/rGO nanohybrid for phenol degradation is as follows (Eqs. (1) to (7) and FIG. 11).

[Equations]

Mn(IV)+HSO₅⁻→Mn(III)+HO*+SO₄*⁻ (1)

Mn(III)+HSO₅⁻→Mn(IV)+SO₅*⁻+H⁺ (2)

Fe(II)+HSO₅⁻→Fe(III)+SO₄*⁻+OH⁻ (3)

Fe(III)+HSO₅⁻→Fe(II)+SO₅*⁻−+H⁺ (4)

2SO₅*⁻⁺²OH^{-→2}SO₄²⁻+2HO*+O₂ (5)

Fe(III)+Mn(III)→Fe(II)+Mn(IV) (6)

SO₄*⁻+HO*+C₆H₆OH→Several steps→CO₂+H₂O+SO₄²⁻ (7)

The Mn(IV)/Mn(III) and Fe(II)/Fe(III) transitions involve electron transfer, which is responsible for the catalytic reaction. In the first stage, the active sites of both MnO₂ and ZnFe₂O₄ on the nanohybrid can activate PMS to generate active radicals (Eqs. (1) to (4)), which can contribute to phenol degradation (Eq. (7)). Hydroxyl radicals (HO) are generated further after the depletion of SO₄*⁻ in a rapid reaction with phenol in the first stage (Eq. (5)), and HO* becomes the only radical that reacts with phenol in the last stage of the reaction. The return to the original oxidation states of the metals (Mn(IV) and Fe(II)) is due to the recovery reactions on the reduced hybrid (Eq. (6)).

1. A three-dimensional (3D) MnO₂@ZnFe₂O₄/rGO nanohybrid catalyst comprising:
reduced graphene oxide (rGO);
zinc ferrite (ZnFe₂O₄) nanoparticles dispersed in the rGO; and
manganese dioxide (MnO₂) nanoflakes attached three-dimensionally on the rGO.

2. The 3D MnO₂@ZnFe₂O₄/rGO nanohybrid catalyst according to claim 1, wherein the manganese dioxide (MnO₂) is in the gamma (γ) form.

3. The 3D MnO₂@ZnFe₂O₄/rGO nanohybrid catalyst according to claim 1, wherein an average thickness of the manganese dioxide (MnO₂) nanoflakes is 2 to 5 nm.

4. The 3D MnO₂@ZnFe₂O₄/rGO nanohybrid catalyst according to claim 1,
wherein the MnO₂@ZnFe₂O₄/rGO nanohybrid has a Brunauer-Emmett-Teller (BET) specific surface area of 200 to 500 m²/g and includes pores with an average diameter of 2 to 15 nm.

5. A catalyst for decomposing harmful organic waste comprising the 3D MnO₂@ZnFe₂O₄/rGO nanohybrid catalyst according to claim 1 and peroxymonosulfate (PMS).

6. A method for preparing a three-dimensional (3D) MnO₂@ZnFe₂O₄/rGO nanohybrid catalyst, comprising:
dispersing zinc ferrite (ZnFe₂O₄) nanoparticles in a graphene oxide (GO) solution to prepare a ZnFe₂O₄/GO solution;
adding a manganese precursor and an acid to the ZnFe₂O₄/GO solution to prepare a suspension; and
performing heat treatment of the suspension to obtain a nanohybrid (MnO₂@ZnFe₂O₄/rGO) with manganese dioxide (MnO₂) nanoflakes attached three-dimensionally on reduced graphene oxide (rGO) in which the zinc ferrite (ZnFe₂O₄) nanoparticles are dispersed.

7. The method according to claim 6, wherein the manganese precursor is any one selected from the group consisting of potassium permanganate (KMnO₄), manganese nitrate (Mn(NO₃)₂), manganese hydrochloride (MnCl₂), manganese sulfate (MnSO₄), and manganese acetate (Mn(CH₃COO)₂).

8. The method according to claim 6, wherein the acid is any one selected from the group consisting of hydrochloric acid (HCl), sulfuric acid (H₂SO₄), and nitric acid (HNO₃).

9. The method according to claim 6, wherein 0.1 to 0.7 g of the manganese precursor is included, and 0.3 to 2.0 mL of the acid is included.

10. The method according to claim 6, wherein the heat treatment of the suspension is carried out at 50 to 150° C. for 5 to 20 hours.

11. The method according to claim 6, wherein an average thickness of the manganese dioxide (MnO₂) nanoflakes is 2 to 5 nm.

12. The method according to claim 6, wherein the MnO₂@ZnFe₂O₄/rGO nanohybrid has a BET specific surface area of 200 to 500 m²/g and includes pores with an average diameter of 2 to 15 nm.
